(19) United States
(12) Patent Application Publication
(10) Pub. No.: US 2017/0293639 A1
(43) Pub. Date: Oct. 12, 2017

(54) VEHICLE DRIVER'S INTENTION INDICATION SYSTEM

(71) Applicant: Hoon Kyu LEE, Suwon-si (KR)

(72) Inventor: Hoon Kyu LEE, Suwon-si (KR)

(21) Appl. No.: 15/294,902

(22) Filed: Oct. 17, 2016

(30) Foreign Application Priority Data
Apr. 12, 2016 (KR) 20-2016-0001972

(51) Int. Cl. G06F 17/30; G06K 9/00; B60Q 1/50; G10L 15/26

(52) U.S. Cl. CPC G06F 17/30268; G10L 15/26; G06K 9/00791; G06F 17/30752; B60Q 1/503; G06K 2209/15

(57) ABSTRACT

A vehicle driver's intention indication system comprise a display device to display a driver's intention in a rear direction; a sound input device to receive a driver voice; a sound converter configured to convert digital sound data to visual content corresponding to the driver voice; an imaging device configured to generate a vehicle rear image; a vehicle number extraction unit configured to extract a rear vehicle number from the vehicle rear image; and a vehicle electronic controller configured to control the sound converter and the vehicle number extraction unit to output the visual content and the rear vehicle number to the display device, wherein a combination of the visual content and the rear vehicle number is displayed on the display device.

### CROSS-REFERENCE TO RELATED APPLICATION

This application claims the benefit of Korea Utility Model Application No. 20-2016-0001972 filed on Apr. 12, 2016, the entire content of which is incorporated herein by reference for all purposes as if fully set forth herein.

### BACKGROUND

### Field of the Present Disclosure

The present disclosure relates to a vehicle driver's intention indication system to communicate the vehicle driver's intention with another vehicle driver.

### Discussion of Related Art

During driving, there are many direction changes which cause car accidents or personal conflicts between the drivers. Korean patent application publication number 10-2007-0041279 discloses a black box system for a vehicle and a method for automatically reporting vehicle accidents to an insurance company and a policy station by using the same are provided to scientifically/correctly perform an accident analysis by recording the vehicle accident and fairly/correctly process insurance money by automatically reporting the vehicle accident to the insurance company and the policy station.

However, there is not yet disclosed a vehicle driver's intention indication system to communicate the vehicle driver's intention with another vehicle driver. There is a need for the vehicle driver's intention indication system to communicate the vehicle driver's intention with another vehicle driver, to suppress between the personal conflicts between the drivers.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a vehicle driver's intention indication system to communicate the vehicle driver's intention with another vehicle driver.

In one aspect of the present disclosure, there is provided a vehicle driver's intention indication system comprising: a display device disposed at a rear portion of a vehicle to display a driver's intention in a rear direction; a sound input device disposed adjacent to a driver seat of the vehicle to receive a driver voice; a sound reader configured to read the driver voice and generate digital sound data therefrom; a sound converter configured to convert the digital sound data to visual content corresponding to the driver voice; an imaging device configured to generate a vehicle rear image where the image is related to a scene in a rear of the vehicle; a vehicle number extraction unit configured to extract a rear vehicle number from the vehicle rear image, wherein the rear vehicle number is a number of another vehicle in a rear of the vehicle; and a vehicle electronic controller configured to control the sound converter and the vehicle number extraction unit to output the visual content and the rear vehicle number to the display device, wherein a combination of the visual content and the rear vehicle number is displayed on the display device.

In one implementation, the sound converter is configured to convert the digital sound data to a text sentence, wherein the vehicle electronic controller is configured to control the sound converter to output the text sentence to the display device.

In one implementation, the sound converter is configured to convert the digital sound data to an image, wherein the vehicle electronic controller is configured to control the sound converter to output the image to the display device.

In one implementation, the system further comprises a keyword-based text storage to store first database including a correspondence between a keyword and an associated text sentence.

In one implementation, the sound converter is configured to extract the keyword from the input voice, to retrieve the first database based on the extracted keyword, and output the text sentence associated with the keyword.

In one implementation, the system further comprises a keyword-based image storage to store first database including a correspondence between a keyword and an associated image.

In one implementation, the sound converter is configured to extract the keyword from the input voice, to retrieve the first database based on the extracted keyword, and output the image associated with the keyword.

In accordance with the present disclosure, the current vehicle driver may communicate his/her intention to following vehicle drivers to prevent personal conflicts between them due to the drive direction change of the current driver.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 illustrates a state where a display device is disposed at a rear portion of a vehicle and a sound input device is disposed adjacent to a vehicle driver seat, in accordance with one embodiment of the present disclosure.

FIG. 2 and FIG. 3 illustrate states where driver's intentions are displayed on a display device in accordance with one embodiment of the present disclosure.

FIG. 4 is a block diagram of a vehicle driver's intention indication system in accordance with one embodiment of the present disclosure.

FIG. 5 illustrates one example of a table indicating between a keyword and an associated text sentence, in accordance with one embodiment of the present disclosure.

FIG. 6 is a block diagram of a vehicle driver's intention indication system in accordance with another embodiment of the present disclosure.

FIG. 7 illustrates a state where a vehicle has a rear imaging device at a rear portion thereof, in accordance with another embodiment of the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, s, operations, elements, and/or components, but do not preclude the presence or addition of one or more other features, integers, s, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein,

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

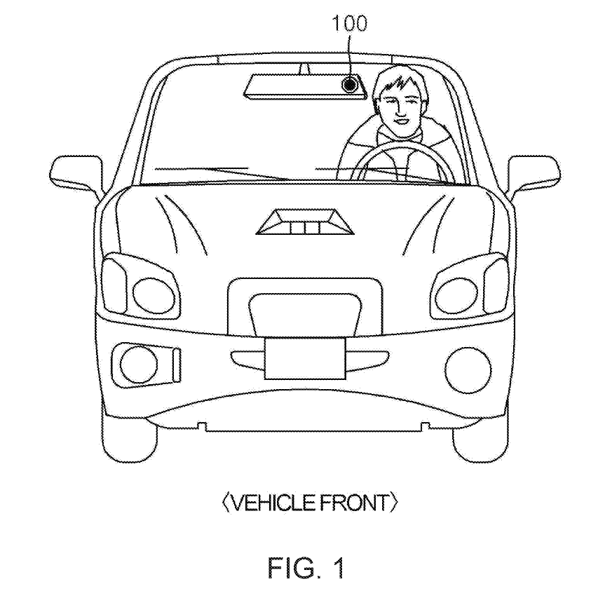

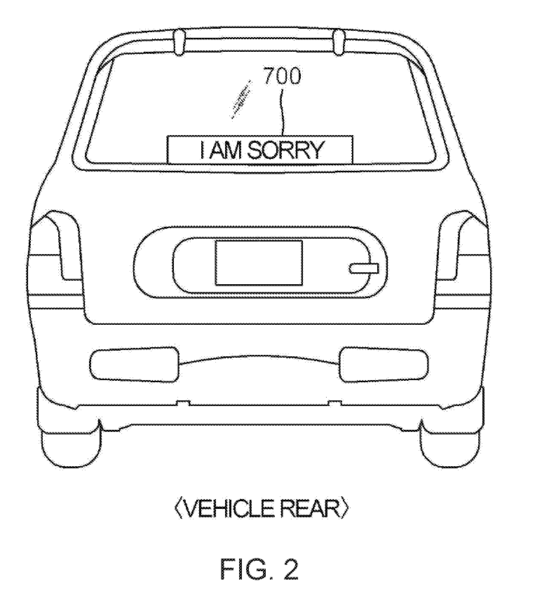

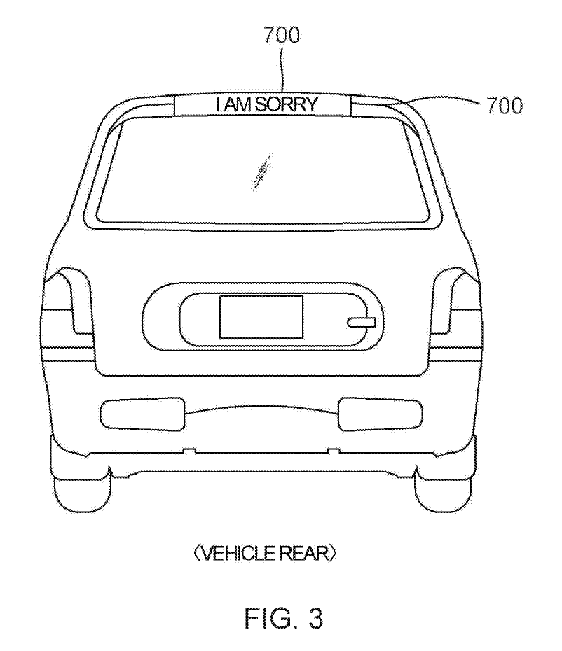

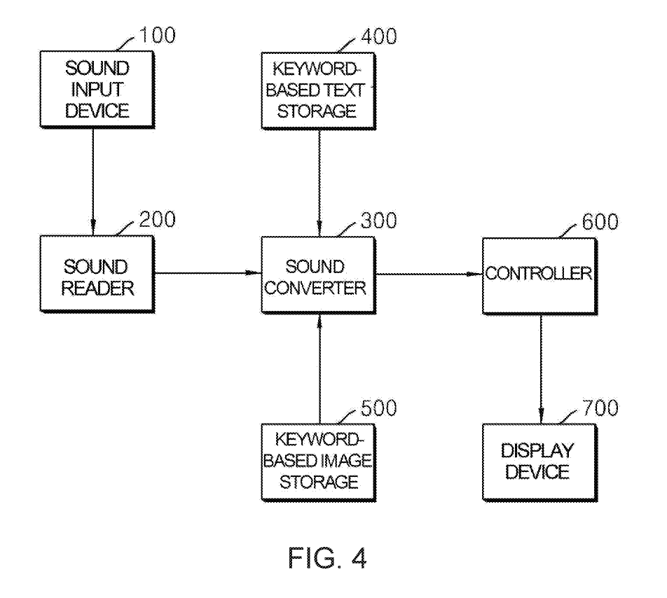

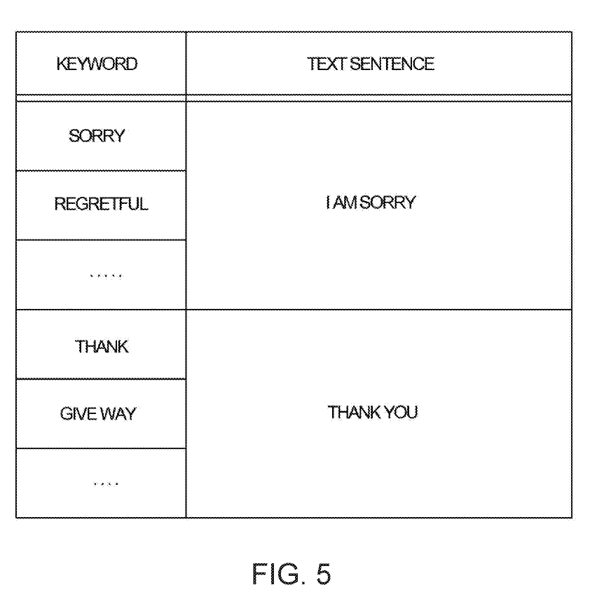

FIG. 1 illustrates a state where a display device is disposed at a rear portion of a vehicle and a sound input device is disposed adjacent to a vehicle driver seat, in accordance with one embodiment of the present disclosure. FIG. 2 and FIG. 3 illustrate states where driver's intentions are displayed on a display device in accordance with one embodiment of the present disclosure. FIG. 4 is a block diagram of a vehicle driver's intention indication system in accordance with one embodiment of the present disclosure. FIG. 5 illustrates one example of a table indicating between a keyword and an associated text sentence, in accordance with one embodiment of the present disclosure.

The present disclosure may include a sound input device 100 disposed nearby a driver seat as shown in FIG. 1, and a display device 700 disposed at a rear portion of a vehicle as shown in FIG. 2 and FIG. 3. When the driver inputs his/her intention into the sound input device 100 using a voice, the voice data is converted to data to be displayed from the display device 700 and, then, the driver intention is displayed in the display device 700 to be displayed to another driver of a vehicle following the current vehicle. Thus, for example, when the driver inputs input a voice “I am sorry” to the sound input device 100, the intention “I am sorry” is displayed on the display device 700 as shown in FIG. 2 and FIG. 3.

A driver's intention indication system in accordance with the present disclosure may include, as shown in FIG. 4, a display device 700, a sound input device 100, a sound reader 200, a sound converter 300, and a vehicle electronic controller 600. The driver's intention indication system may further include a keyword-based text storage 400, and a keyword-based image storage 500.

The display device 700 may be disposed at the rear portion of the current vehicle to display the driver's intention in a rear direction. The display device 700 may include, for example, LED, OLED, etc. In one example, the display device 700 may be disposed on a rear glass of the vehicle. For example, as shown in FIG. 2, the display device 700 may be disposed adjacent to an auxiliary stop indication lamp on the rear glass of the vehicle. For another example, as shown in FIG. 3, the display device 700 may be disposed adjacent to an air spoiler in a SUV vehicle. In another example, the display device 700 may be disposed elsewhere on the rear portion of the vehicle to display the driver's intention in a rear direction.

The sound input device 100 may receive a driver' voice. The sound input device 100 may include a microphone. The sound input device 100 may be installed at a rear mirror centered in an inner space in the vehicle, or may be installed in a steering handle, or may be disposed on a dash-board or on an inner face of a ceiling of the vehicle. However, the present disclosure is not limited thereto. The sound input device 100 may be installed at any location as long as it could sense the driver' voice.

The sound reader 200 may be configured to read the driver's voice and then generate sound data in a digital form. Thus, the sound reader 200 may have a codec module to code sound data in an analog form into sound data in a digital form. If necessary, the sound reader 200 may have a noise filter configured to remove a noise from the analog sound data.

The sound converter 300 may be configured to convert the digital sound data into visual content. The visual content may include text or image.

As for an example when the digital sound data is converted to the text, the sound converter 300, the driver voice “I am sorry” may be converted to the text “I am sorry”.

Further, the vehicle driver's intention indication system may include a keyword-based text storage 400 to store first database including a correspondence between a keyword and an associated text sentence. For example, as shown in FIG. 5, a keyword “sorry” may be associated with the text sentence “I am sorry”. In another example, a keyword “give way” may be associated with the text sentence “please, give way for me”.

Thus, the sound converter 300 may be configured to extract a keyword from the input voice, retrieve the first database based on the extracted keyword, and output a text sentence associated with the keyword.

For example, when the input voice is “very sorry” or “am sorry”, the sound converter 300 may extract the keyword “sorry” from the input voice, retrieve the first database based on the extracted keyword “sorry”, and output the text sentence “I am sorry” associated with the keyword.

The keyword-based text storage 400 may include, by way of example, Hard Disk Drive, Solid State Drive, Flash Memory, Compact Flash Card, Secure Digital Card, Smart Media Card, Multi-Media Card or Memory Stick. The keyword-based text storage 400 may be implemented in a machine-readable media or computer readable media, which includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

As for one example when the sound converter 300 output the image, the vehicle driver's intention indication system may include a keyword-based image storage 500 to store second database including a correspondence between a keyword and an associated image. For example, as shown in FIG. 5, a keyword “sorry” may be associated with the image expressing a facial or gesture image indicating that the driver is sorry.

Thus, the sound converter 300 may be configured to extract a keyword from the input voice, retrieve the second database based on the extracted keyword, and output an image associated with the keyword.

For example, when the input voice is “very sorry” or “am sorry”, the sound converter 300 may extract the keyword “sorry” from the input voice, retrieve the second database based on the extracted keyword “sorry”, and output the image of a gesture expressing that the driver is sorry.

The vehicle electronic controller 600 may include an ECU (Electric

Control Unit) to control various functional modules of the vehicle. The vehicle electronic controller 600 may communicate with the sound input device 100, and the display device 700 over a CAN communication protocol. The communication protocols may not be limited thereto.

When the driver inputs the voice, the vehicle electronic controller 600 may control the sound converter 300 to output visual content including text or image converted from the sound data to the display device 700. For example, when the sound input device 100 receives the voice “I am sorry”, the vehicle electronic controller 600 may control the sound converter 300 to output, to the display device 700, the text “I am sorry” and/or the image of a gesture expressing that the driver is sorry.

In this way, another driver for a vehicle following the vehicle may receive the intention of the vehicle of the current driver via the display device 700. Thus, conflict between them may be settled.

All of the voice data input into the sound input device 100 may not be displayed into the display device 700. Only when the driver of the current vehicle intends to communicate his/her intention with the driver of the following vehicle, the intention of the driver may be displayed to the display device 700. To this ends, the vehicle electronic controller 600 may be configured such that when only the driver turns on a separate intention activation button (not shown), all of the voice data input into the sound input device 100 may be displayed into the display device 700.

In one embodiment, the present system may be configured to display the driver's intention to a target vehicle driver. This may be useful when the current driver may give thanks to the rear-located vehicle driver who gave way for the current driver.

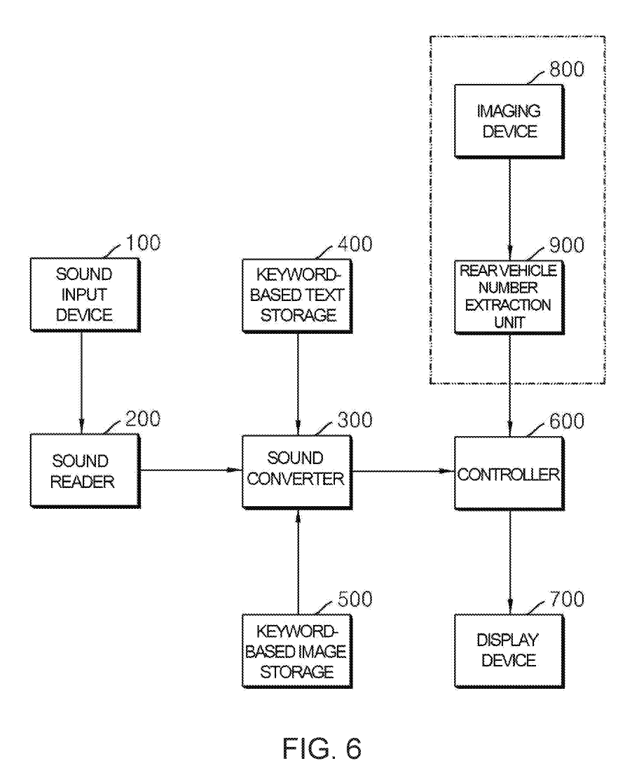

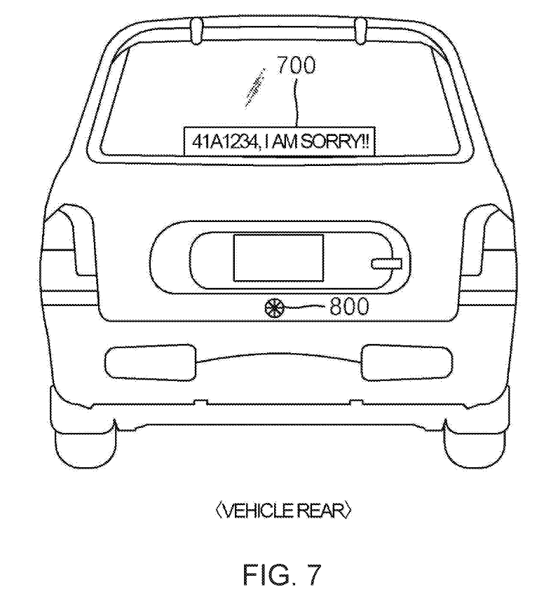

The present system to have the communication of the intentions with the target vehicle driver will be described with reference to the FIG. 6 and FIG. 7.

FIG. 6 is a block diagram of a vehicle driver's intention indication system in accordance with another embodiment of the present disclosure. FIG. 7 illustrates a state where a vehicle has a rear imaging device at a rear portion thereof, in accordance with another embodiment of the present disclosure.

As shown in FIG. 6, the vehicle driver's intention indication system in accordance with another embodiment of the present disclosure may include the display device 700, the sound input device 100, the sound reader 200, the sound converter 300, the vehicle electronic controller 600, an imaging device 800, and a vehicle number extraction unit 900. The display device 700, the sound input device 100, the sound reader 200, the sound converter 300, and the vehicle electronic controller 600 may have the same configurations respectively as those as described with reference to FIG. 4.

The imaging device 800 may be implemented, for example, using a camera. The imaging device 800 may be disposed at a rear portion of the current car. For example, the imaging device 800 may be disposed at a rear bumper of the vehicle. The imaging device 800 may be configured to image a scene in a rear of the current vehicle to generate a vehicle rear image. The vehicle rear image may contain the number of the vehicle in a rear of the current vehicle.

The vehicle number extraction unit 900 may be configured to extract a rear vehicle number from the vehicle rear image. The vehicle number extraction unit 900 may extract a rear vehicle number from the vehicle rear image using well-known character-extraction algorithms to the skilled person to the art.

The vehicle electronic controller 600 may be configured such that the visual content converted from the voice is displayed together with the rear vehicle number. For example, when the rear vehicle has the vehicle number “41 A1234”, the display device may display the message “41 A1234, Thank you!!”. In this way, the communication of the intentions with the target vehicle driver may be achieved.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A vehicle driver's intention indication system comprising:
a display device disposed at a rear portion of a vehicle to display a driver's intention in a rear direction;
a sound input device disposed adjacent to a driver seat of the vehicle to receive a driver voice;
a sound reader configured to read the driver voice and generate digital sound data therefrom;
a sound converter configured to convert the digital sound data to visual content corresponding to the driver voice;
an imaging device configured to generate a vehicle rear image where the image is related to a scene in a rear of the vehicle;
a vehicle number extraction unit configured to extract a rear vehicle number from the vehicle rear image, wherein the rear vehicle number is a number of another vehicle in a rear of the vehicle; and
a vehicle electronic controller configured to control the sound converter and the vehicle number extraction unit to output the visual content and the rear vehicle number to the display device, wherein a combination of the visual content and the rear vehicle number is displayed on the display device.

2. The system of claim 1, wherein the sound converter is configured to convert the digital sound data to a text sentence, wherein the vehicle electronic controller is configured to control the sound converter to output the text sentence to the display device.

3. The system of claim 1, wherein the sound converter is configured to convert the digital sound data to an image, wherein the vehicle electronic controller is configured to control the sound converter to output the image to the display device.

4. The system of claim 2, further comprising a keyword-based text storage to store first database including a correspondence between a keyword and an associated text sentence.

5. The system of claim 4, wherein the sound converter is configured to extract the keyword from the input voice, to retrieve the first database based on the extracted keyword, and output the text sentence associated with the keyword.

6. The system of claim 3, further comprising a keyword-based image storage to store first database including a correspondence between a keyword and an associated image.

7. The system of claim 6, wherein the sound converter is configured to extract the keyword from the input voice, to retrieve the first database based on the extracted keyword, and output the image associated with the keyword.
